(19) United States
(12) Patent Application Publication
(10) Pub. No.: US 2025/0390148 A1
(43) Pub. Date: Dec. 25, 2025

(54) Case with Keyboard for Portable Electronic Device

(71) Applicant: Pioneer Square Brands, Inc., High Point, NC (US)

(72) Inventors: Brian Lewis Piper, Seattle, WA (US); Sudeep Balkrishna Agalgaonkar, Jamestown, NC (US)

(73) Assignee: Pioneer Square Brands, Inc., High Point, NC (US)

(21) Appl. No.: 18/766,523

(22) Filed: Jul. 8, 2024

Related U.S. Application Data
(60) Provisional application No. 63/662,389, filed on Jun. 20, 2024.

(51) Int. Cl. G06F 1/16

(52) U.S. Cl. CPC G06F 1/1669; G06F 1/1628

(57) ABSTRACT

Systems and methods are involved with (I) a case assembly including a first side including at least one distal wall portion, and at least one proximal wall portion, and a second side including at least one distal wall portion, and at least one proximal wall portion; and (II) a keyboard assembly including a first side removably couplable to the at least one distal wall portion of the first side of the case assembly, and a third side extending perpendicular to the base and extending perpendicular to the second side, the third side removably couplable to the at least one distal wall portion of the third side of the case assembly. In addition, other aspects are described in the claims, drawings, and text forming a part of the present disclosure.

### SUMMARY

In one or more aspects, a system for a portable electronic device can include, but is not limited to, (I) a case assembly including (A) a base, (B) a first side extending perpendicular to the base, the first side including at least one distal wall portion, at least one middle wall portion, and at least one proximal wall portion, wherein the at least one distal wall portion is farther from the base than the at least one proximal wall portion is from the base, wherein the at least one middle wall portion is between the at least one distal wall portion and the at least one proximal wall portion, (C) a second side extending perpendicular to the base and extending perpendicular to the first side, (D) a third side extending perpendicular to the base and extending perpendicular to the second side, the third side including at least one distal wall portion, at least one middle wall portion, and at least one proximal wall portion, wherein the at least one distal wall portion is farther from the base than the at least one proximal wall portion is from the base, wherein the at least one middle wall portion is between the at least one distal wall portion and the at least one proximal wall portion, and (E) a fourth side extending perpendicular to the base and extending perpendicular to the first side; and (II) a keyboard assembly including (A) a base, (B) a first side extending perpendicular to the base, the first side removably couplable to the at least one distal wall portion of the first side of the case assembly, (C) a second side extending perpendicular to the base and extending perpendicular to the first side, (D) a third side extending perpendicular to the base and extending perpendicular to the second side, the third side removably couplable to the at least one distal wall portion of the third side of the case assembly, and (E) a fourth side extending perpendicular to the base and extending perpendicular to the first side. In implementations the first side includes at least one portable electronic device support portion of the first side extending perpendicular to the at least one middle wall portion, and wherein the third side includes at least one portable electronic device support portion of the third side extending perpendicular to the at least one middle wall portion.

In implementations the first side includes at least one portable electronic device support portion of the first side extending perpendicular to the at least one middle wall portion, and wherein the third side includes at least one portable electronic device support portion of the third side extending perpendicular to the at least one middle wall portion.

In implementations the first side includes at least one portable electronic device support portion of the first side extending perpendicular to the at least one middle wall portion, and wherein the third side includes at least one portable electronic device support portion of the third side extending perpendicular to the at least one middle wall portion.

In implementations the at least one keyboard support portion of the first side is closer to the at least one distal wall portion of the first side than the at least one portable electronic device support portion of the first side is to the at least one distal wall portion of the first side, and wherein the at least one keyboard support portion of the third side is closer to the at least one distal wall portion of the third side than the at least one portable electronic device support portion of the third side is to the at least one distal wall portion of the third side.

In implementations the at least one keyboard support portion of the first side is a flexible material, and wherein the at least one keyboard support portion of the third side is a flexible material.

In implementations the at least one middle wall portion of the first side is removably couplable with the portable electronic device, and wherein the at least one middle wall portion of the third side is removably couplable with the portable electronic device.

In implementations the first side of the keyboard assembly is frictionally couplable to the at least one distal wall portion of the first side of the case assembly, and wherein the third side of the keyboard assembly is frictionally couplable to the at least one distal wall portion of the third side of the case assembly.

In implementations the first side of the keyboard includes at least one protrusion that is removably couplable to the at least one distal wall portion of the first side of the case assembly, and wherein the third side of the keyboard includes at least one protrusion that is removably couplable to the at least one distal wall portion of the third side of the case assembly.

In implementations the at least one distal wall portion of the first side of the case assembly includes at least one protrusion that is removably couplable to the first side of the keyboard assembly, and wherein the at least one distal wall portion of the third side of the case assembly includes at least one protrusion that is removably couplable to the third side of the keyboard assembly.

In implementations the first side of the keyboard includes at least one protrusion, wherein the at least one distal wall portion of the first side of the case assembly includes at least one protrusion, wherein the at least one protrusion of the first side of the keyboard is removably couplable with the at least one protrusion of the at least one distal wall portion of the first side of the case assembly, wherein the third side of the keyboard includes at least one protrusion, wherein the at least one distal wall portion of the third side of the case assembly includes at least one protrusion, and wherein the at least one protrusion of the third side of the keyboard is removably couplable with the at least one protrusion of the at least one distal wall portion of the third side of the case assembly.

In implementations the case assembly includes at least one semi-rigid portion to allow for uncoupling of the portable electronic device from the case assembly when the portable electronic device is coupled to the case assembly.

In implementations the second side of the case assembly includes an interior portion and an exterior portion, wherein the case assembly includes an electrical cable assembly having an electrical connector, wherein the second side of the case assembly includes an aperture from the exterior portion of the second side through the side second to the interior portion of the second side, wherein the electrical cable assembly includes an electrical connector assembly, wherein the electrical connector assembly extends from the exterior portion of the second side through the aperture of second side to extend past the interior portion of the second side, wherein a portion of the electrical cable assembly extends along the exterior portion of the second side, wherein a portion of the electrical cable assembly extends along the interior portion of the second side, wherein the third side of the case assembly includes an interior portion, wherein a portion of the electrical cable assembly extends along the interior portion of the third side, and wherein the electrical cable assembly is electrically coupled to the keyboard assembly.

In implementations the third side of the case assembly includes an exterior portion with a stylus-shaped recess.

In implementations the flexible hinge is coupled to the case assembly, and wherein the flexible hinge is coupled to the keyboard assembly.

In one or more aspects, a system for a portable electronic device can include, but is not limited to, (I) a case assembly including (A) a base, (B) a first side extending perpendicular to the base, the first side including at least one distal wall portion, and at least one proximal wall portion, and wherein the at least one distal wall portion is farther from the base than the at least one proximal wall portion is from the base, and (C) a second side extending perpendicular to the base and extending parallel with the first side, the second side including at least one distal wall portion, and at least one proximal wall portion, wherein the at least one distal wall portion is farther from the base than the at least one proximal wall portion is from the base; and (II) a keyboard assembly including (A) a base, (B) a first side extending perpendicular to the base, the first side removably couplable to the at least one distal wall portion of the first side of the case assembly, wherein the first side of the keyboard includes at least one protrusion that is removably couplable to the at least one distal wall portion of the first side of the case assembly, and (C) a second side extending perpendicular to the base and extending parallel with to the first side, the second side removably couplable to the at least one distal wall portion of the second side of the case assembly, wherein the second side of the keyboard includes at least one protrusion that is removably couplable to the at least one distal wall portion of the second side of the case assembly.

In implementations the first side includes at least one keyboard support portion and at least one portable electronic device support portion, wherein the at least one keyboard support portion of the first side extends perpendicular to the at least one distal wall portion of the first side, wherein the at least one portable electronic device support portion of the first side extends perpendicular to the at least one distal wall portion of the first side, wherein the at least one keyboard support portion of the first side is closer to the at least one distal wall portion of the first side than the at least one portable electronic device support portion of the first side is to the at least one distal wall portion of the first side, wherein the second side includes at least one keyboard support portion and at least one portable electronic device support portion, wherein the at least one keyboard support portion of the second side extends perpendicular to the at least one distal wall portion of the second side, wherein the at least one portable electronic device support portion of the second side extends perpendicular to the at least one distal wall portion of the second side, and wherein the at least one keyboard support portion of the second side is closer to the at least one distal wall portion of the second side than the at least one portable electronic device support portion of the second side is to the at least one distal wall portion of the second side.

In implementations the at least one keyboard support portion of the first side is a flexible material, and wherein the at least one keyboard support portion of the second side is a flexible material.

In one or more aspects, a system for a portable electronic device can include, but is not limited to, (I) a case assembly including (A) a base, (B) a first side extending perpendicular to the base, the first side including at least one distal wall portion, and at least one proximal wall portion, wherein the at least one distal wall portion is farther from the base than the at least one proximal wall portion is from the base, (C) a second side extending perpendicular to the base and extending perpendicular to the first side, and (D) a third side extending perpendicular to the base and extending perpendicular to the first side, the third side including at least one distal wall portion, and at least one proximal wall portion, wherein the at least one distal wall portion is farther from the base than the at least one proximal wall portion is from the base; and (II) a keyboard assembly including (A) a base, (B) a first side extending perpendicular to the base, the first side removably couplable to the at least one distal wall portion of the first side of the case assembly, wherein the distal wall portion of the first side of the case assembly includes at least one protrusion that is removably couplable to the first side of the keyboard assembly, (C) a second side extending perpendicular to the base and extending perpendicular to the first side, and (D) a third side extending perpendicular to the base and extending perpendicular to the second side, the third side removably couplable to the at least one distal wall portion of the third side of the case assembly, wherein the distal wall portion of the third side of the case assembly includes at least one protrusion that is removably couplable to the third side of the keyboard assembly.

In implementations the first side of the keyboard includes at least one protrusion, wherein the at least one protrusion of the first side of the keyboard is removably couplable with the at least one protrusion of the distal wall portion of the first side of the case assembly, wherein the third side of the keyboard includes at least one protrusion, and wherein the at least one protrusion of the third side of the keyboard is removably couplable with the at least one protrusion of the distal wall portion of the third side of the case assembly.

In implementations the second side of the case assembly includes an interior portion and an exterior portion, wherein the case assembly includes an electrical cable assembly having an electrical connector, wherein the second side of the case assembly includes an aperture from the exterior portion of the second side through the side second to the interior portion of the second side, wherein the electrical cable assembly includes an electrical connector assembly, wherein the electrical connector assembly extends from the exterior portion of the second side through the aperture of second side to extend past the interior portion of the second side, wherein a portion of the electrical cable assembly extends along the exterior portion of the second side, wherein a portion of the electrical cable assembly extends along the interior portion of the second side, wherein the third side of the case assembly includes an interior portion, wherein a portion of the electrical cable assembly extends along the interior portion of the third side, and wherein the electrical cable assembly is electrically coupled to the keyboard assembly.

In addition to the foregoing, other aspects are described in the claims, drawings, and text forming a part of the disclosure set forth herein. Various other aspects are set forth and described in the teachings such as text (e.g., claims and/or detailed description) and/or drawings of the present disclosure. The foregoing is a summary and thus may contain simplifications, generalizations, inclusions, and/or omissions of detail; consequently, those skilled in the art will appreciate that the summary is illustrative only and is NOT intended to be in any way limiting. Other aspects, features, and advantages of the devices and/or processes and/or other subject matter described herein will become apparent in the teachings set forth herein.

### BRIEF DESCRIPTION OF THE FIGURES

FIG. 1 is a top plan view of a case assembly of a portable electronic device keyboard-case system.

FIG. 2 is a front perspective view of the view of the case assembly of FIG. 1.

FIG. 3 is a front perspective view of the view of the case assembly of FIG. 1.

FIG. 4 is a front perspective view of the view of the case assembly of FIG. 1.

FIG. 5 is a front perspective view of the view of the case assembly of FIG. 1.

FIG. 6 is a front perspective view of the view of the case assembly of FIG. 1.

FIG. 7 is a front perspective view of the view of the case assembly of FIG. 1.

FIG. 8 is a top plan of a portable electronic device.

FIG. 9 is a front perspective view of a portable electronic device.

FIG. 10 is a front perspective view of the portable electronic device of FIG. 9 with a cable assembly.

FIG. 11 is a top plan view of a keyboard assembly of the portable electronic device keyboard-case.

FIG. 12 is a front perspective view of the keyboard assembly of FIG. 12.

FIG. 13 is a side elevational view of the keyboard assembly of FIG. 12.

FIG. 14 is a top plan view of a internal portion of the keyboard assembly of FIG. 12.

FIG. 15 is a top plan view of the keyboard assembly of FIG. 12 with the cable assembly of FIG. 11.

FIG. 16 is a front perspective view of the keyboard assembly of FIG. 12 with the cable assembly of FIG. 11.

FIG. 17 is a top plan view of the portable electronic device of FIG. 9 coupled with the case assembly of FIG. 1.

FIG. 18 is a front perspective view of the portable electronic device of FIG. 9 coupled with the case assembly of FIG. 1.

FIG. 19 is a front perspective view of the keyboard assembly of FIG. 12 coupled with the case assembly of FIG. 1.

FIG. 20 is a front perspective view of the portable electronic device of FIG. 9 coupled with a portion of the case assembly of FIG. 1 and the cable assembly of FIG. 11.

FIG. 21 is a front perspective view of the keyboard assembly of FIG. 12 and the case assembly of FIG. 1 both coupled with the cable assembly of FIG. 11.

FIG. 22 is a front perspective view of the keyboard assembly of FIG. 12 and a portion of the case assembly of FIG. 1 both coupled with the cable assembly of FIG. 11.

FIG. 23 is a front perspective view of the keyboard assembly of FIG. 12 coupled with the case assembly of FIG. 1.

FIG. 24 is a rear perspective view of the keyboard assembly of FIG. 12 coupled with the case assembly of FIG. 1.

FIG. 25 is a top plan view of an internal portion of the keyboard assembly of FIG. 12 coupled with a portion of the cable assembly of FIG. 11.

FIG. 26 is a front perspective view of the keyboard assembly of FIG. 12 and the case assembly of FIG. 1 coupled with the portable electronic device of FIG. 9 with all coupled with the cable assembly of FIG. 11.

FIG. 27 is a bottom perspective view of the keyboard assembly of FIG. 12 coupled with the case assembly of FIG. 1.

FIG. 28 is a front perspective view of the keyboard assembly of FIG. 12 coupled with the case assembly of FIG. 1 coupled with the portable electronic device of FIG. 9.

FIG. 29 is a top plan view of the keyboard assembly of FIG. 12 coupled with the case assembly of FIG. 1.

FIG. 30 is a front perspective view of the keyboard assembly of FIG. 12 coupled with the case assembly of FIG. 1.

For a more complete understanding of implementations, reference now is made to the following descriptions taken in connection with the accompanying drawings. The use of the same symbols in different drawings typically indicates similar or identical items, unless context dictates otherwise.

With reference now to the figures, shown are one or more examples of Case with Keyboard for Portable Electronic Computing Device, articles of manufacture, compositions of matter for same that may provide context, for instance, in introducing one or more processes and/or devices described herein.

### DETAILED DESCRIPTION

In the following detailed description, reference is made to the accompanying drawings, which form a part hereof. In the drawings, similar symbols typically identify similar components, unless context dictates otherwise. The illustrative implementations described in the detailed description, drawings, and claims are not meant to be limiting. Other implementations may be utilized, and other changes may be made, without departing from the spirit or scope of the subject matter presented here.

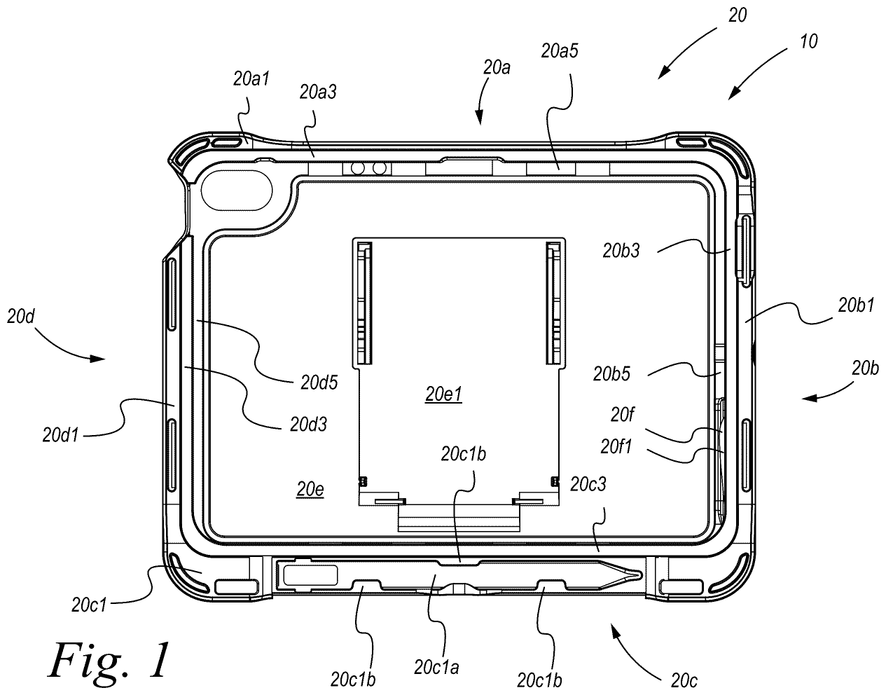

Turning to FIG. 1, depicted therein is a top plan view of case assembly 20 of portable electronic device case system 10. Depicted implementation of case assembly 20 is shown to include side 20a, side 20b, side 20c, side 20d, base 20c, and electrical cable assembly 20f. Depicted implementation of side 20a is shown to include exterior surface portion 20a1, keyboard support portion 20a3, and tablet support portion 20a5. Depicted implementation of side 20b is shown to include exterior surface portion 20b1, keyboard support portion 20b3, and tablet support portion 20b5. Depicted implementation of side 20c is shown to include exterior surface portion 20c1 with stylus-shaped recess 20c1a, tab 20c1b, and keyboard support portion 20c3. Depicted implementation of side 20d is shown to include exterior surface portion 20d1, keyboard support portion 20d3, and tablet support portion 20d5. Depicted implementation of base 20e is shown to include stand assembly 20c1. Depicted implementation of electrical cable assembly 20f is shown to include cable mid portion 20f1.

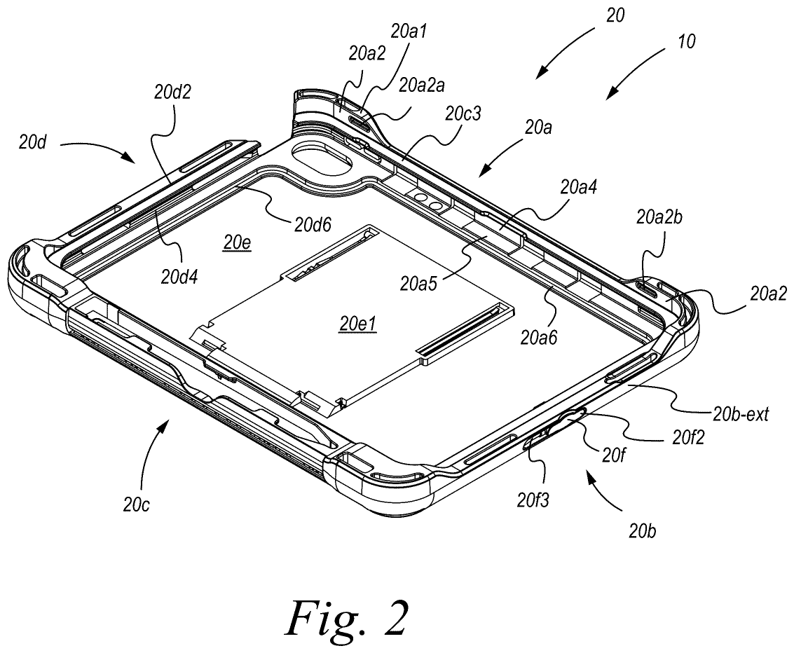

Turning to FIG. 2, depicted therein is a front perspective view of the view of case assembly 20. Depicted implementation of side 20a is shown to include distal wall portion 20a2 with protrusion 20a2a and protrusion 20a2b, middle wall portion 20a4, and proximal wall portion 20a6. Depicted implementation of side 20b is shown to include groove 20b4a and side exterior 20b-ext. Depicted implementation of side 20d is shown to include distal wall portion 20d2, middle wall portion 20d4, and proximal wall portion 20d6. Depicted implementation of electrical cable assembly 20f is shown to include cable end portion 20f2 and cable mid portion 20f3.

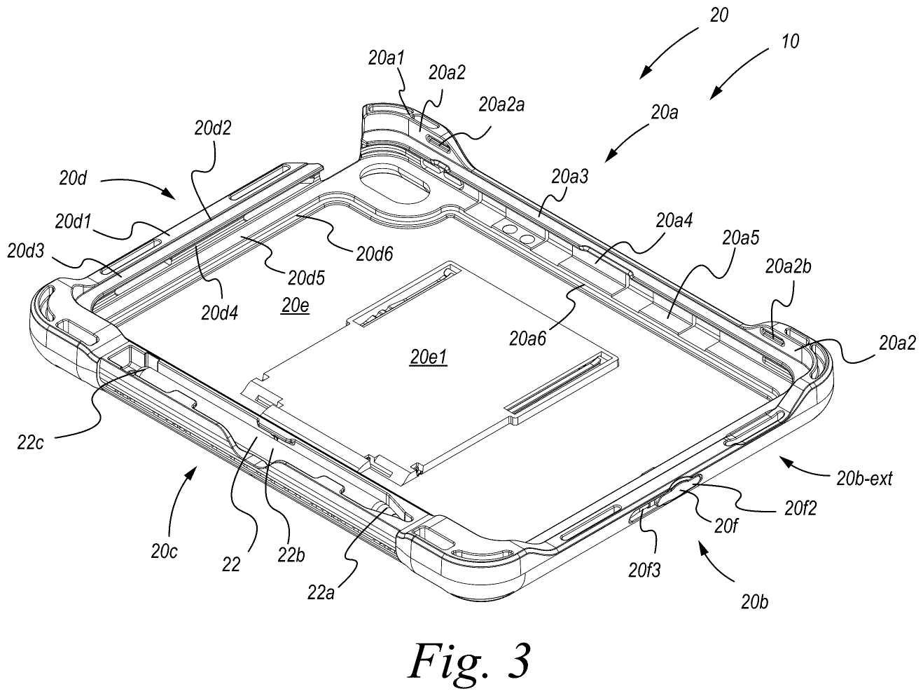

Turning to FIG. 3, depicted therein is a front perspective view of the view of case assembly 20. Depicted implementation of side 20b is shown to include stylus 22 with tapered end portion 22a, middle portion 22b, and end portion 22c.

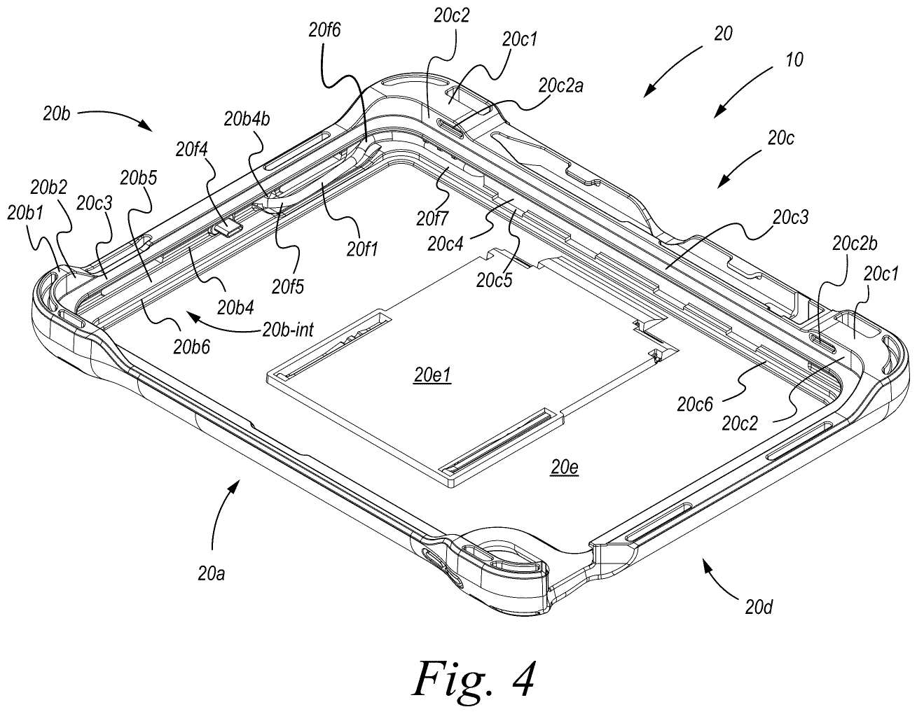

Turning to FIG. 4, depicted therein is a front perspective view of the view of case assembly 20. Depicted implementation of side 20b is shown to include distal wall portion 20b2, middle wall portion 20b4 with aperture 20b4b, tablet support portion 20b5, proximal wall portion 20b6, and side exterior 20b-int. Depicted implementation of side 20c is shown to include.) with protrusion 20c2b and protrusion 20c2a, middle wall portion 20c4, and tablet support portion 20c5. Depicted implementation of electrical cable assembly 20f is shown to include electrical connector assembly 20f4, cable mid portion 20f5, cable mid portion 20f6, and cable mid portion 20f7.

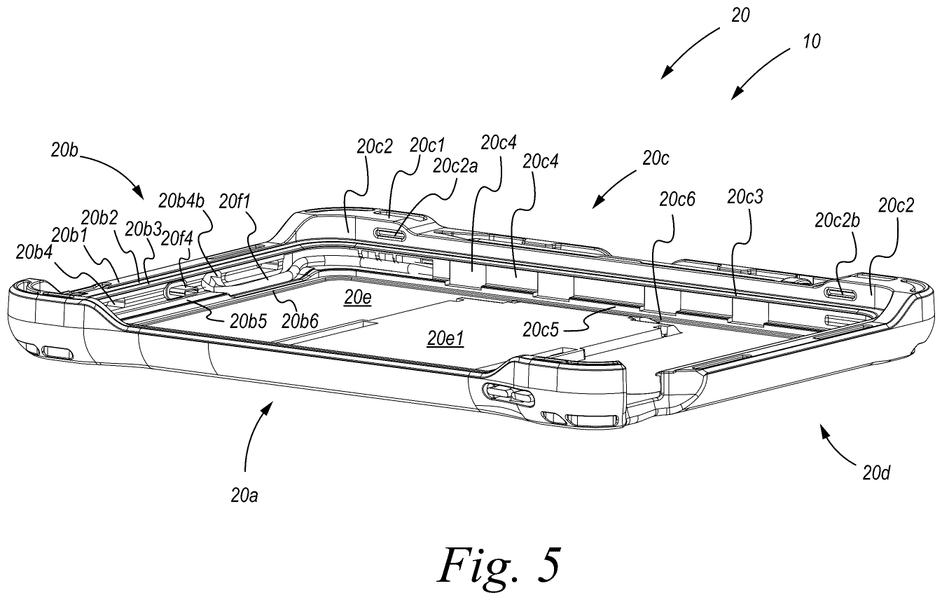

Turning to FIG. 5, depicted therein is a front perspective view of the view of case assembly 20.

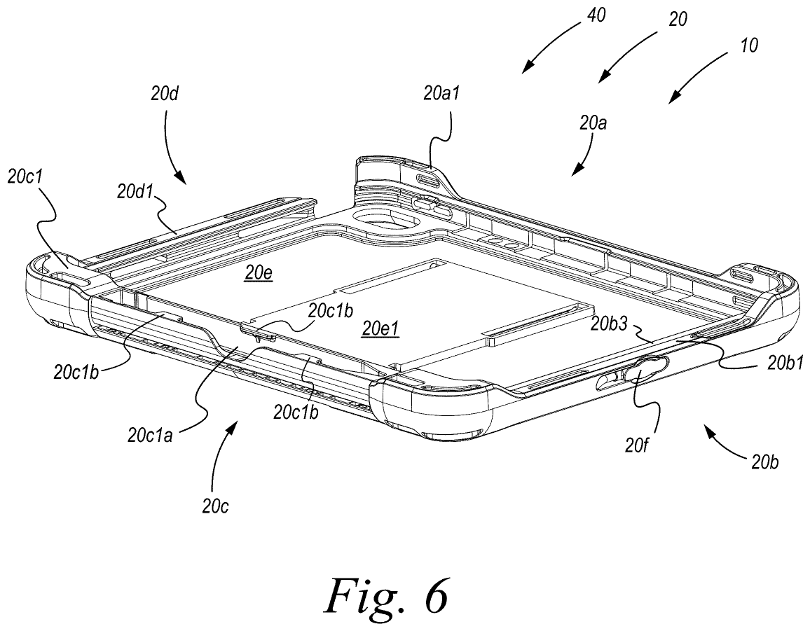

Turning to FIG. 6, depicted therein is a front perspective view of the view of case assembly 20.

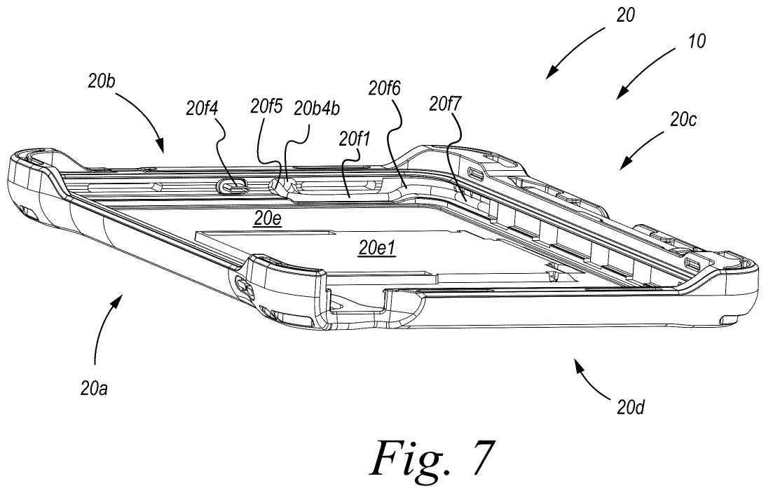

Turning to FIG. 7, depicted therein is a front perspective view of the view of case assembly 20.

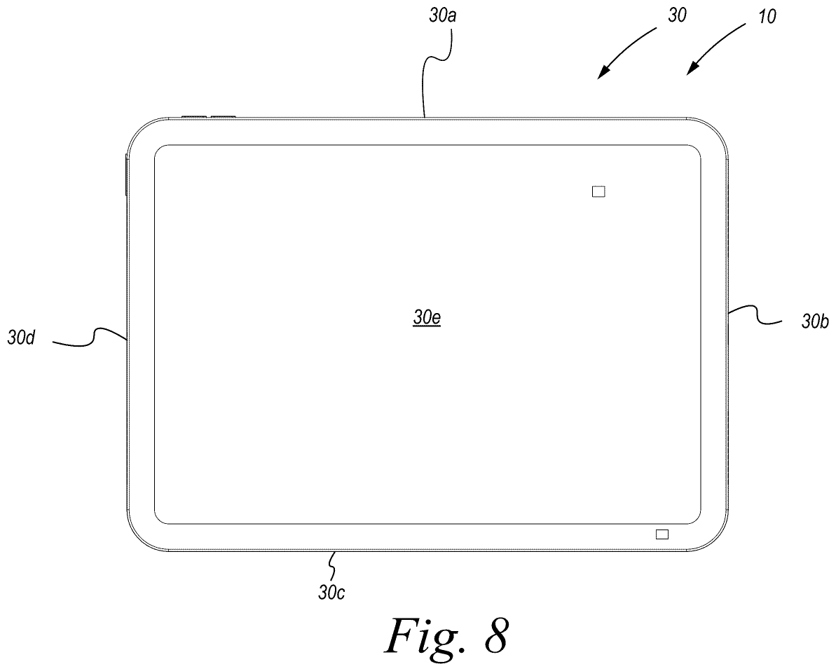

Turning to FIG. 8, depicted therein is a top plan of portable electronic device 30. Depicted implementation of portable electronic device 30 is shown to include side 30a, side 30b, side 30c, side 30d, and display 30e. In implementations keyboard support portion 20a3, keyboard support portion 20b3, keyboard support portion 20c3, or keyboard support portion 20d3 are made from a flexible plastic, etc. to allow for insertion and removal of portable electronic device 30. In implementations side 20a, side 20b, side 20c, side 20d, or base 20e of case assembly 20 are sufficiently semi-rigid to allow for insertion and removal of portable electronic device 30.

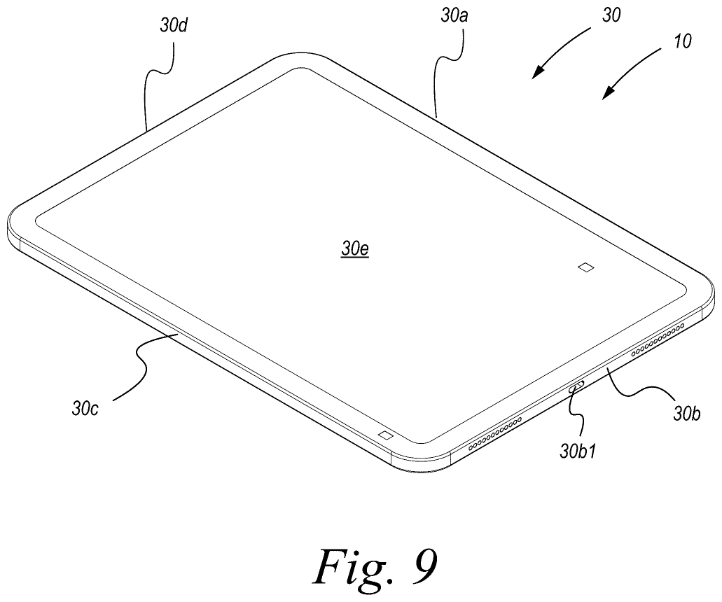

Turning to FIG. 9, depicted therein is a front perspective view of portable electronic device 30. In implementations portable electronic device 30 is removably couplable (e.g., frictionally couplable, etc.) with case assembly 20. Depicted implementation of side 30b is shown to include electrical port 30b1.

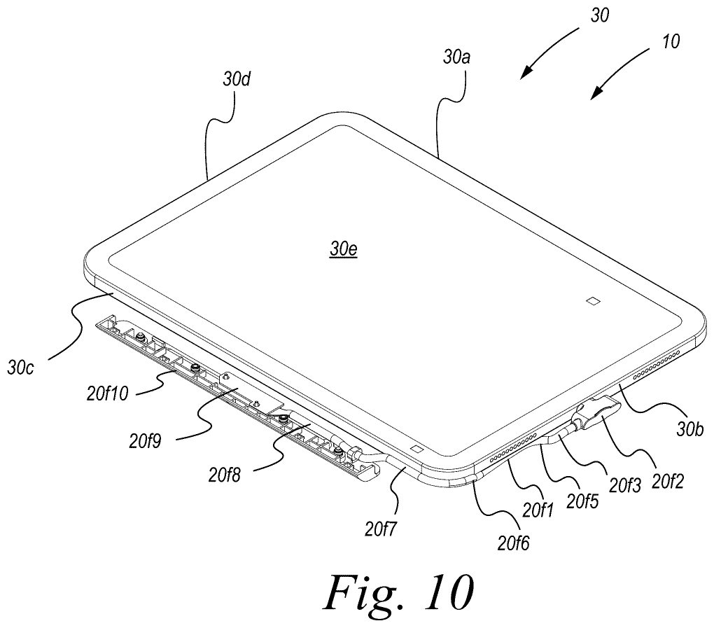

Turning to FIG. 10, depicted therein is a front perspective view of portable electronic device 30 with electrical cable assembly 20f. Depicted implementation of electrical cable assembly 20f is shown to include end cable portion 20f8, coupler bracket 20f9, and coupler bracket 20f10.

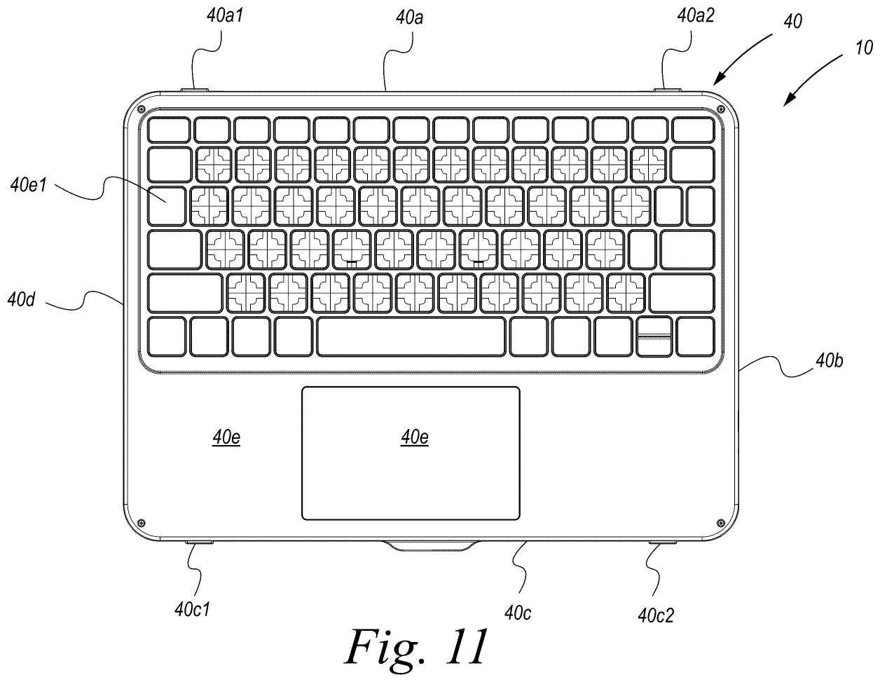

Turning to FIG. 11, depicted therein is a top plan view of keyboard assembly 40 of portable electronic device case system 10. Depicted implementation of keyboard assembly 40 is shown to include side 40a, side 40b, side 40c, side 40d, and base 40e. In implementations keyboard assembly 40 is removably couplable (e.g., frictionally couplable, etc.) with case assembly 20. Depicted implementation of side 40a is shown to include protrusion 40al and protrusion 40a2, which removably couple (e.g., by friction fit, click fit, force fit, etc.) with protrusion 20c2b and protrusion 20c2a, respectively. Depicted implementation of side 40c is shown to include protrusion 40c1 and protrusion 40c2 which removably couple (e.g., by friction fit, click fit, force fit, etc.) with protrusion 20a2a and protrusion 20a2b, respectively. Depicted implementation of base 40e is shown to include keys 40e1 and track pad 40e2.

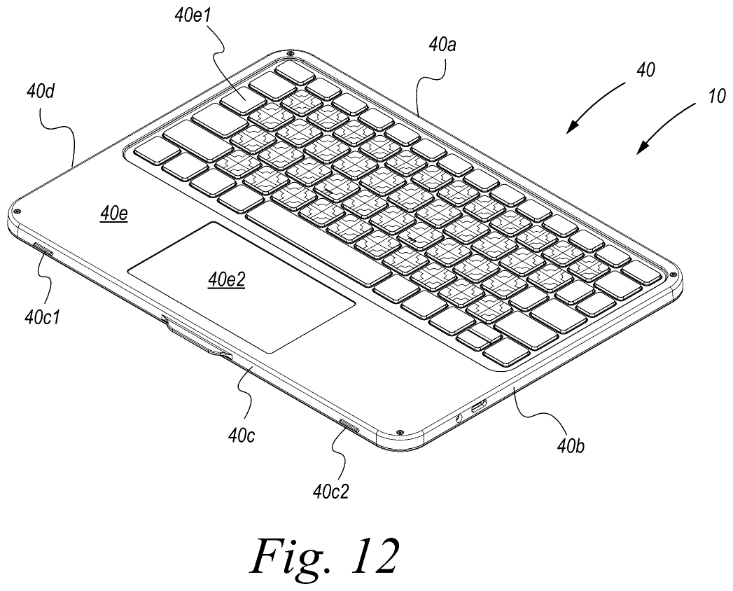

Turning to FIG. 12, depicted therein is a front perspective view of keyboard assembly 40.

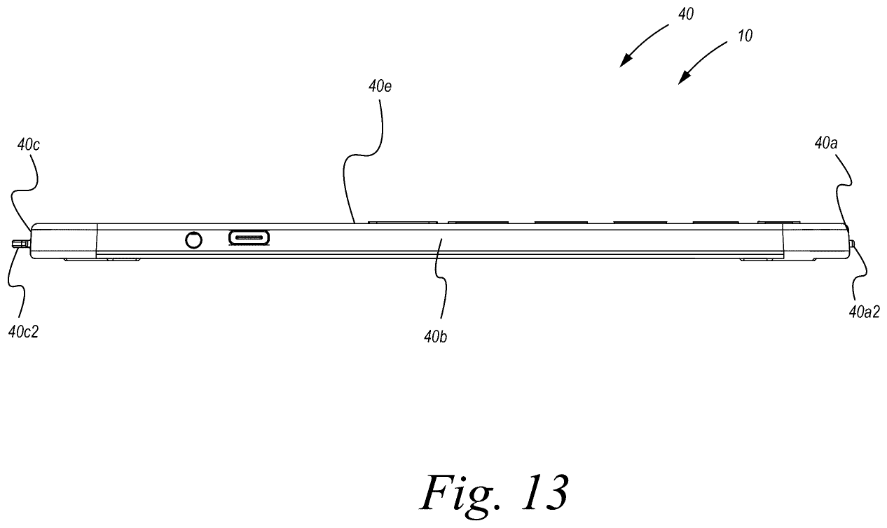

Turning to FIG. 13, depicted therein is a side elevational view of keyboard assembly 40.

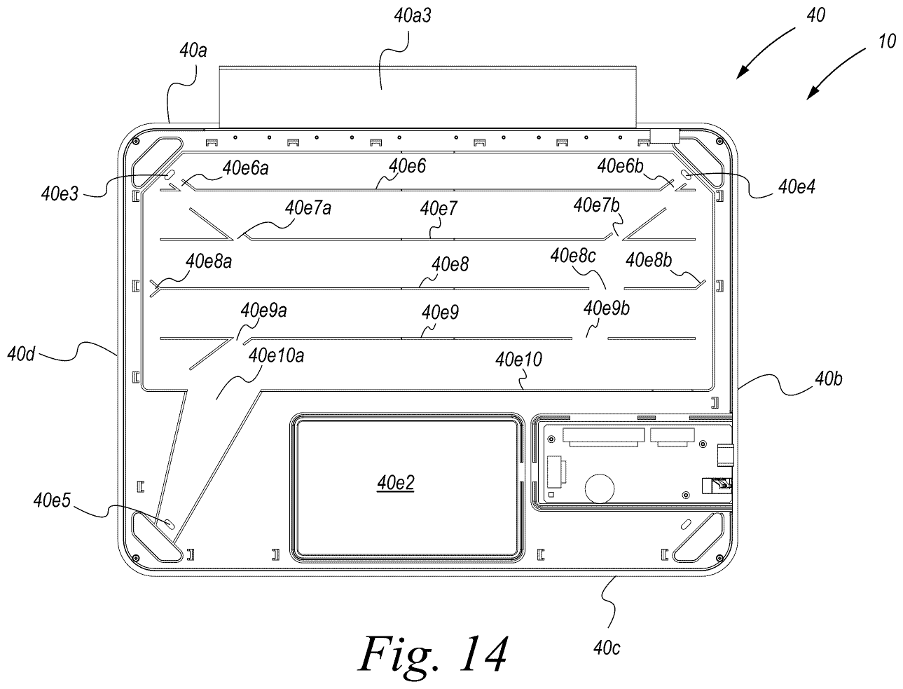

Turning to FIG. 14, depicted therein is a top plan view of a internal portion of keyboard assembly 40. Depicted implementation of side 40a is shown to include flexible hinge 40a3. Depicted implementation of base 40e is shown to include aperture 40e3, aperture 40e4, aperture 40e5, protrusion fluid diverter 40e6, protrusion fluid diverter 40e7, protrusion fluid diverter 40e8, protrusion fluid diverter 40e9, and protrusion fluid diverter 40e10. Depicted implementation of protrusion fluid diverter 40e6 is shown to include channel 40e6a, and channel 40e6b. Depicted implementation of protrusion fluid diverter 40e7 is shown to include channel 40e7a, and channel 40e7b. Depicted implementation of protrusion fluid diverter 40e8 is shown to include channel 40e8a, channel 40e8b, and channel 40e8c. Depicted implementation of protrusion fluid diverter 40e9 is shown to include channel 40e9a and channel 40e9b. Depicted implementation of protrusion fluid diverter 40e 10 is shown to include channel 40e10a.

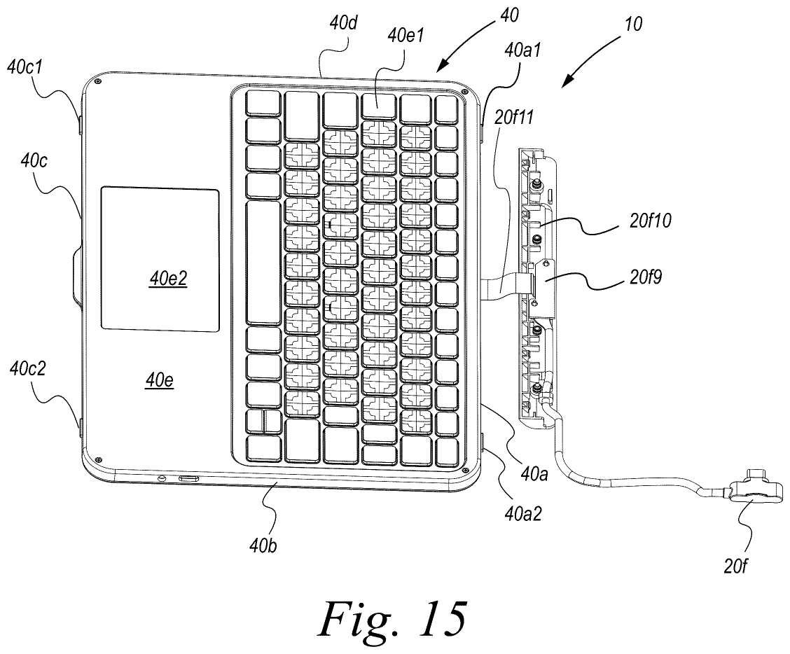

Turning to FIG. 15, depicted therein is a top plan view of keyboard assembly 40 electrically coupled with electrical cable assembly 20f. Depicted implementation of electrical cable assembly 20f is shown to include electrical cable portion 20f11 electrically coupled with keyboard assembly 40.

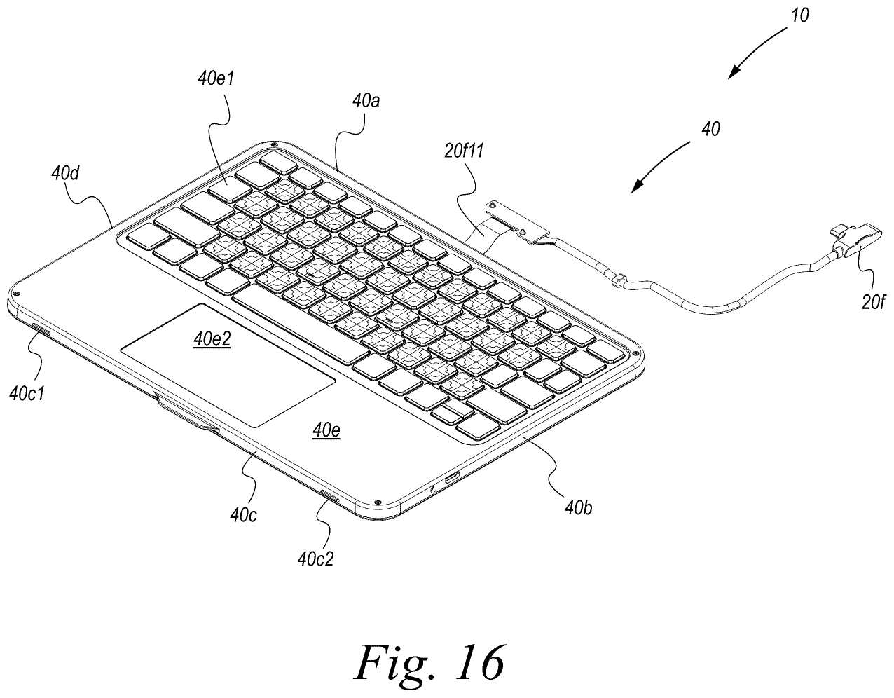

Turning to FIG. 16, depicted therein is a front perspective view of keyboard assembly 40 electrically coupled with electrical cable assembly 20f.

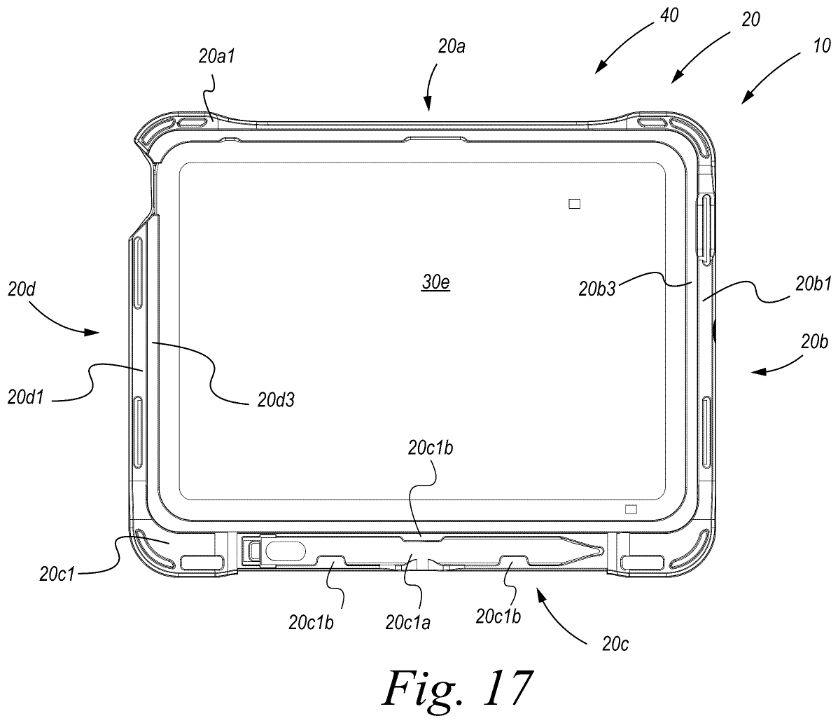

Turning to FIG. 17, depicted therein is a top plan view of portable electronic device 30 coupled with case assembly 20. In implementations portable electronic device 30 is removable couplable with middle wall portion 20a4, middle wall portion 20b4, middle wall portion 20c4, and middle wall portion 20d4 of case assembly 20.

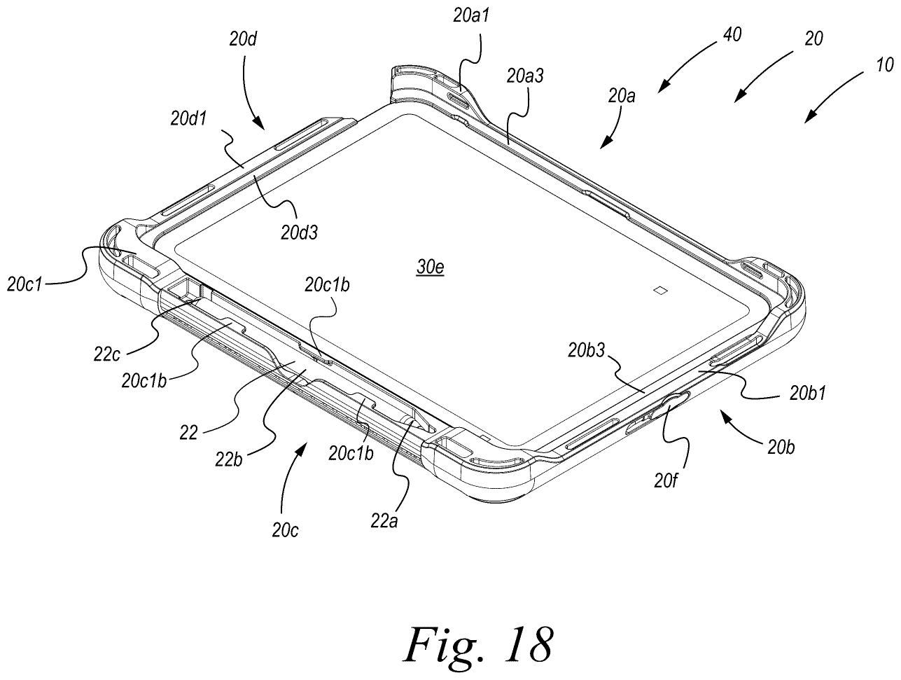

Turning to FIG. 18, depicted therein is a front perspective view of portable electronic device 30 coupled with case assembly 20.

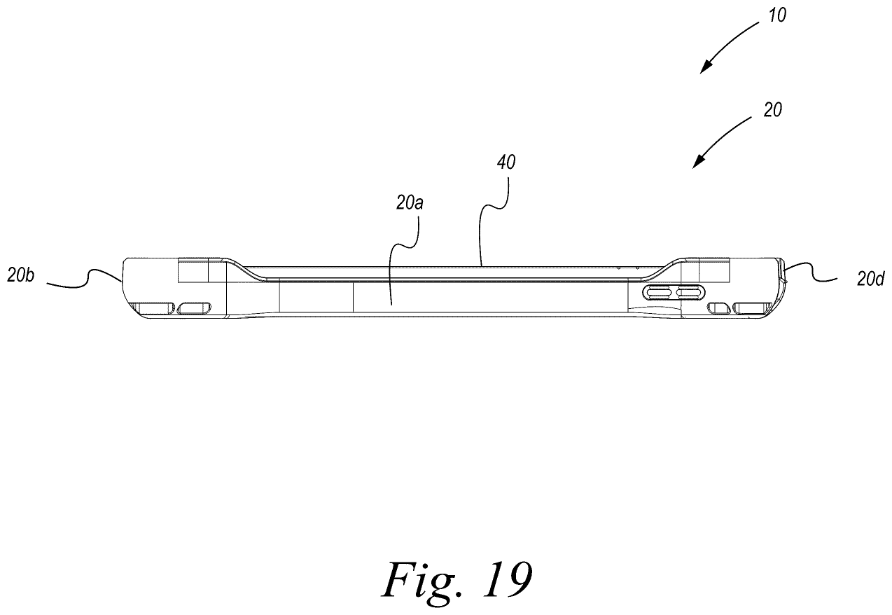

Turning to FIG. 19, depicted therein is a front perspective view of keyboard assembly 40 coupled with case assembly 20.

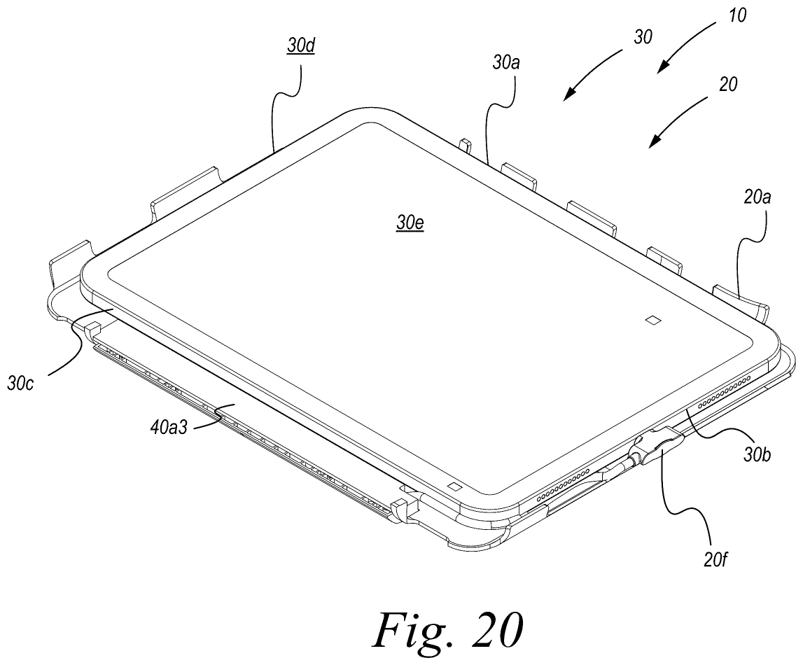

Turning to FIG. 20, depicted therein is a front perspective view of portable electronic device 30 coupled with a portion of case assembly 20 and electrical cable assembly 20f.

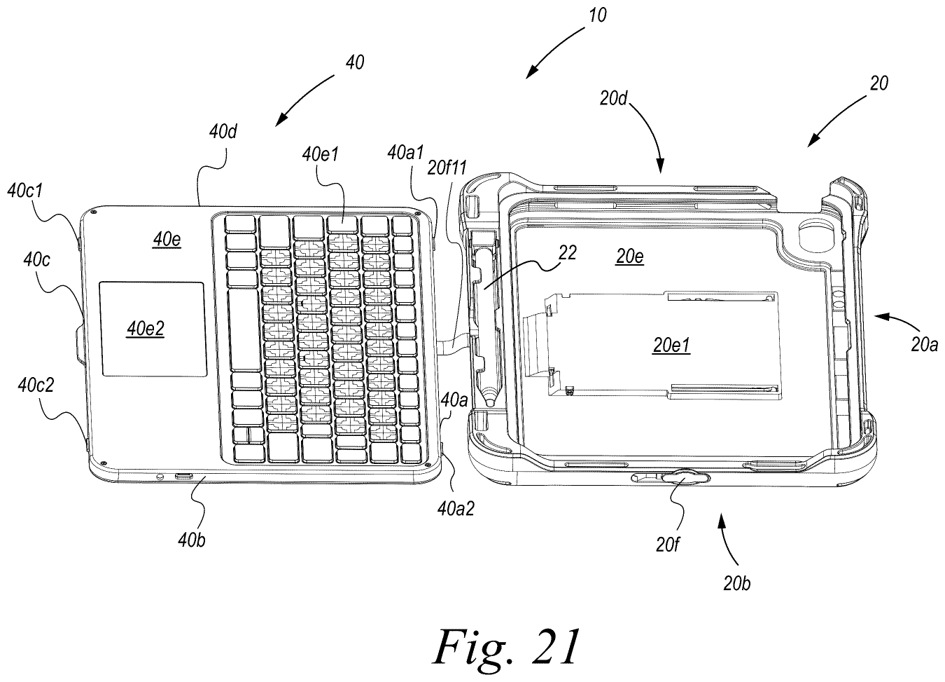

Turning to FIG. 21, depicted therein is a front perspective view of keyboard assembly 40 and case assembly 20 both coupled with electrical cable assembly 20f.

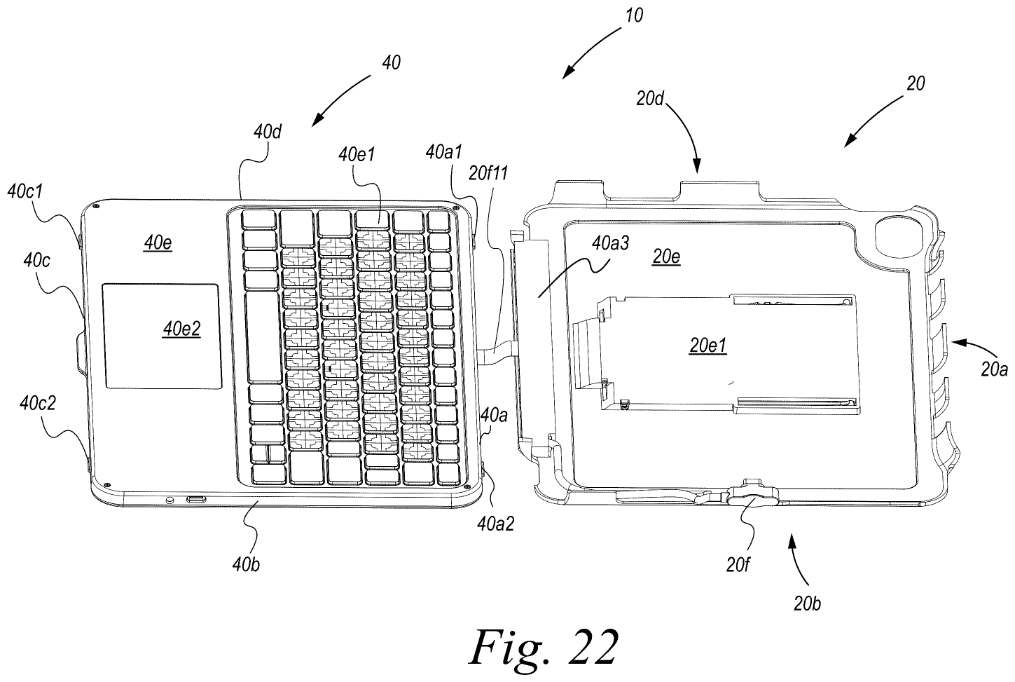

Turning to FIG. 22, depicted therein is a front perspective view of keyboard assembly 40 and a portion of case assembly 20 both coupled with electrical cable assembly 20f.

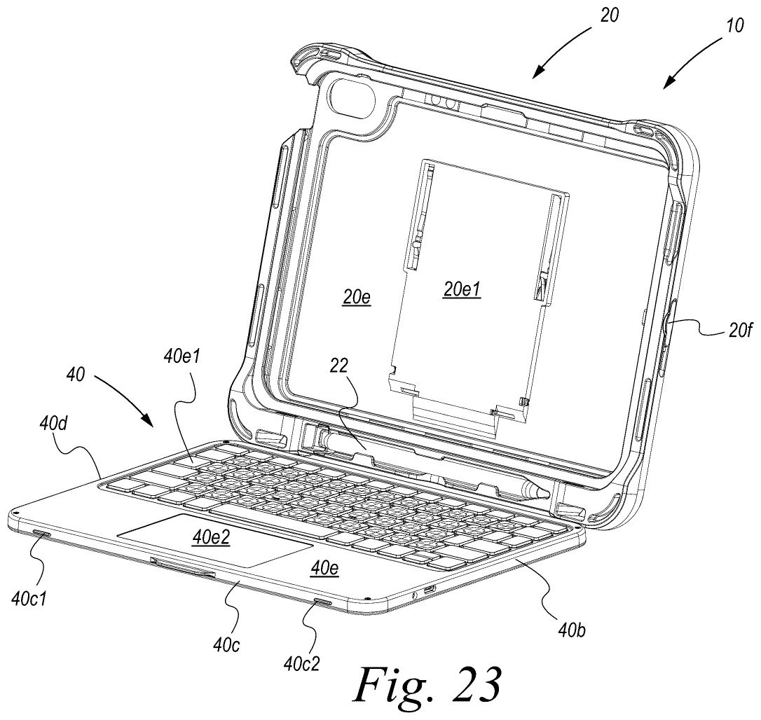

Turning to FIG. 23, depicted therein is a front perspective view of keyboard assembly 40 coupled with case assembly 20.

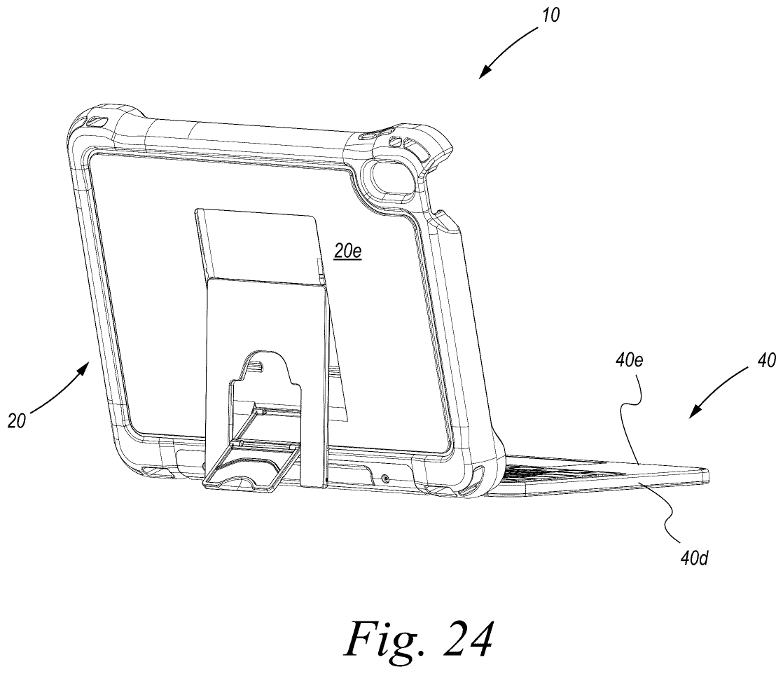

Turning to FIG. 24, depicted therein is a rear perspective view of keyboard assembly 40 coupled with case assembly 20.

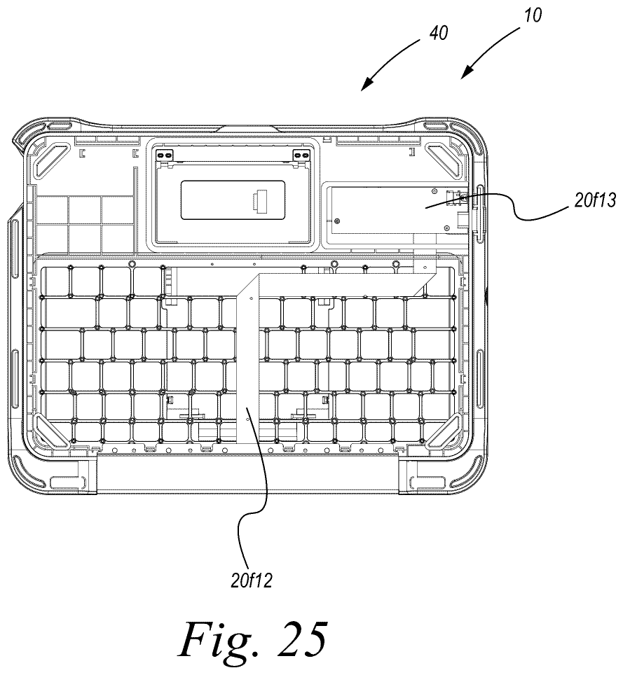

Turning to FIG. 25, depicted therein is a top plan view of an internal portion of keyboard assembly 40 electrically coupled with a portion of electrical cable assembly 20f. Depicted implementation of electrical cable assembly 20f is shown to include electrical cable portion 20f12 and keyboard controller portion 20f13.

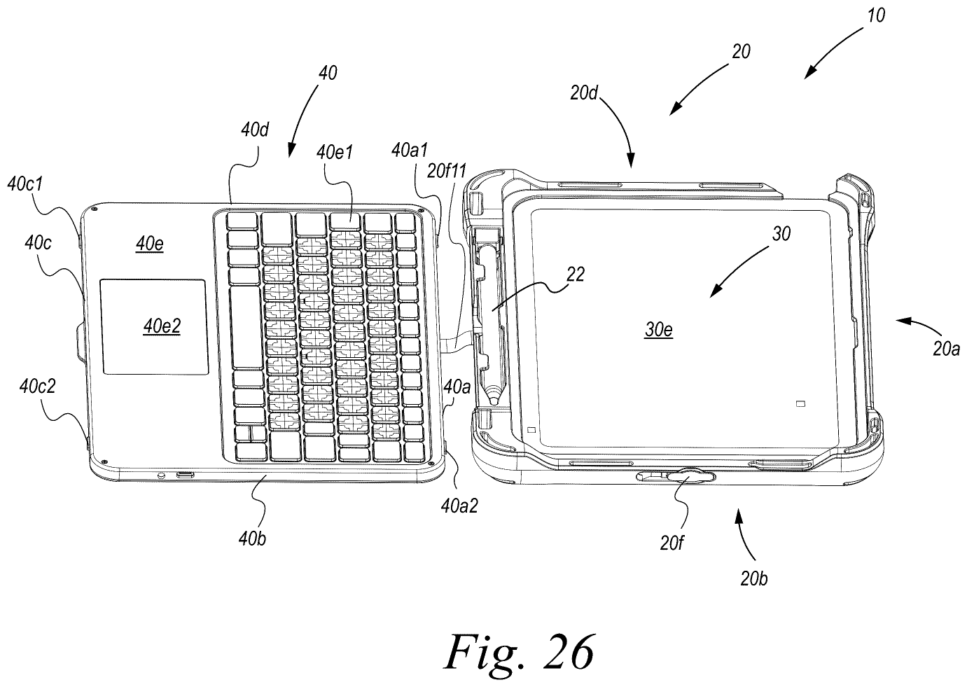

Turning to FIG. 26, depicted therein is a front perspective view of keyboard assembly 40 and case assembly 20 coupled with portable electronic device 30 and all coupled with electrical cable assembly 20f.

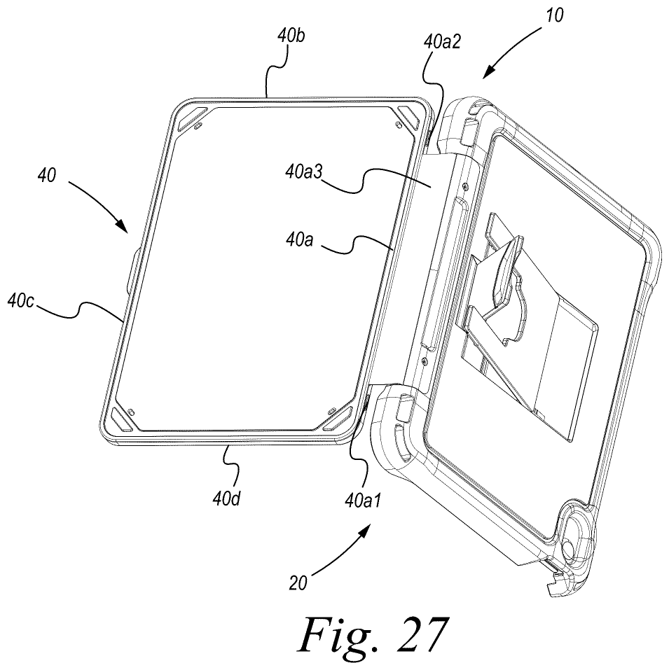

Turning to FIG. 27, depicted therein is a bottom perspective view of keyboard assembly 40 coupled with case assembly 20. As shown, flexible hinge 40a3 is coupled with case assembly 20 and can cover electrical cable portion 20f11.

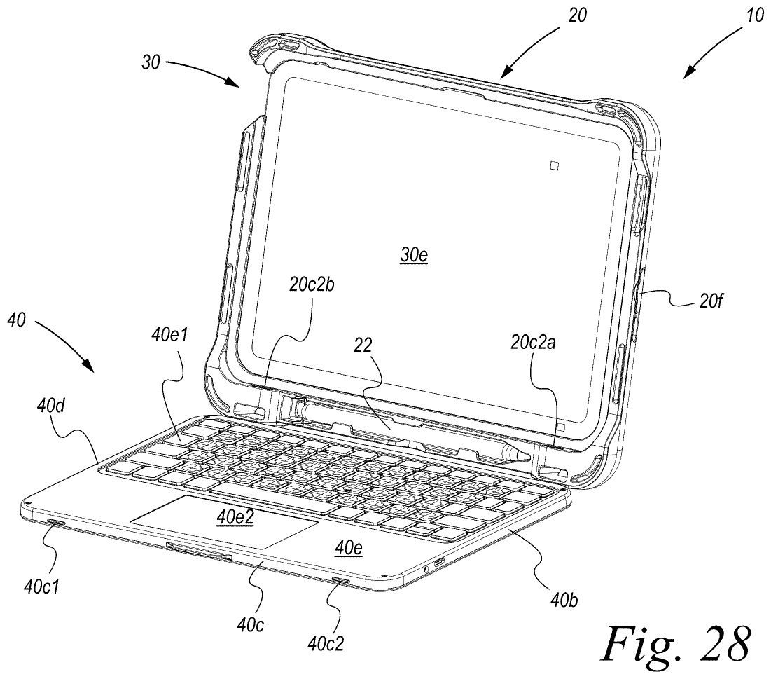

Turning to FIG. 28, depicted therein is a front perspective view of keyboard assembly 40 coupled with case assembly 20 coupled with portable electronic device 30.

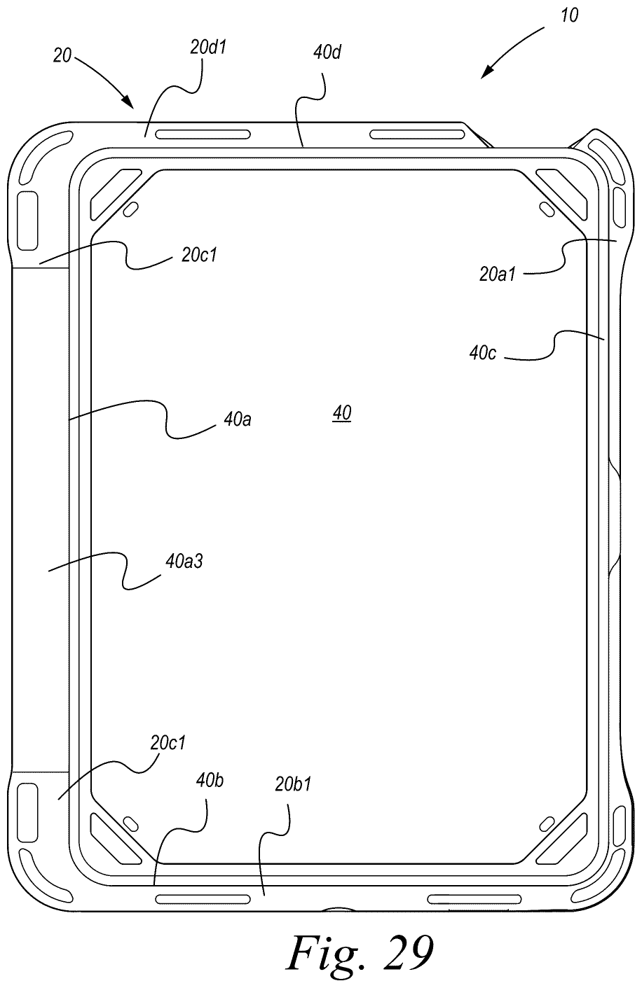

Turning to FIG. 29, depicted therein is a top plan view of the keyboard assembly of FIG. 12 coupled with the case assembly of FIG. 1.

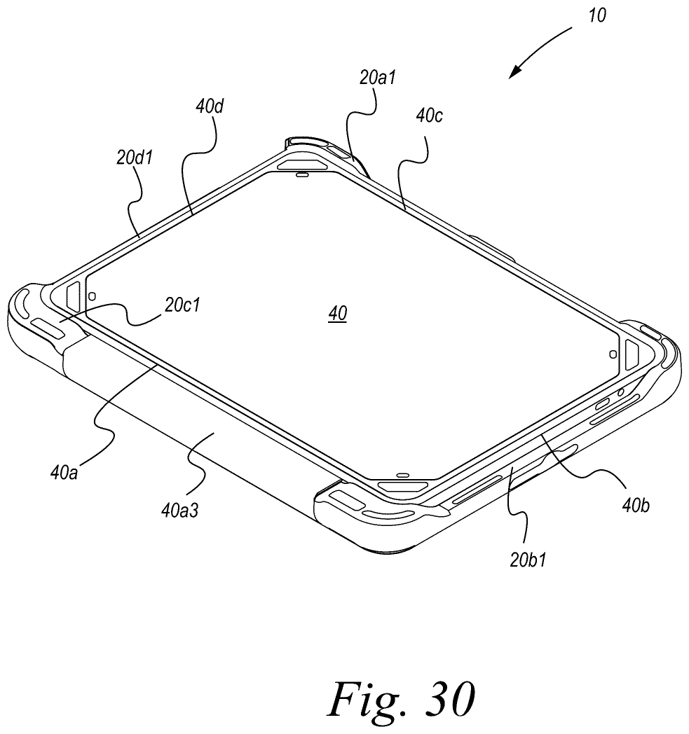

Turning to FIG. 30, depicted therein is a front perspective view of the keyboard assembly of FIG. 12 coupled with the case assembly of FIG. 1.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that typically a disjunctive word and/or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.”

With respect to the appended claims, those skilled in the art will appreciate that recited operations therein may generally be performed in any order. Also, although various operational flows are presented in a sequence(s), it should be understood that the various operations may be performed in other orders than those which are illustrated, or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

What is claimed is:

1. A system for a portable electronic device, the system comprising:
(I) a case assembly including
(A) a base,
(B) a first side extending perpendicular to the base, the first side including at least one distal wall portion, at least one middle wall portion, and at least one proximal wall portion,
wherein the at least one distal wall portion is farther from the base than the at least one proximal wall portion is from the base,
wherein the at least one middle wall portion is between the at least one distal wall portion and the at least one proximal wall portion,
(C) a second side extending perpendicular to the base and extending perpendicular to the first side,
(D) a third side extending perpendicular to the base and extending perpendicular to the second side, the third side including at least one distal wall portion, at least one middle wall portion, and at least one proximal wall portion,
wherein the at least one distal wall portion is farther from the base than the at least one proximal wall portion is from the base,
wherein the at least one middle wall portion is between the at least one distal wall portion and the at least one proximal wall portion, and
(E) a fourth side extending perpendicular to the base and extending perpendicular to the first side; and
(II) a keyboard assembly including
(A) a base,
(B) a first side extending perpendicular to the base, the first side removably couplable to the at least one distal wall portion of the first side of the case assembly,
(C) a second side extending perpendicular to the base and extending perpendicular to the first side,
(D) a third side extending perpendicular to the base and extending perpendicular to the second side, the third side removably couplable to the at least one distal wall portion of the third side of the case assembly, and
(E) a fourth side extending perpendicular to the base and extending perpendicular to the first side.

2. The system of claim 1
wherein the first side includes at least one portable electronic device support portion of the first side extending perpendicular to the at least one middle wall portion, and
wherein the third side includes at least one portable electronic device support portion of the third side extending perpendicular to the at least one middle wall portion.

3. The system of claim 2
wherein the first side includes at least one keyboard support portion,
wherein the at least one keyboard support portion of the first side extends perpendicular to the at least one distal wall portion of the first side,
wherein the third side includes at least one keyboard support portion, and
wherein the at least one keyboard support portion of the third side extends perpendicular to the at least one distal wall portion of the third side.

4. The system of claim 3
wherein the at least one keyboard support portion of the first side is closer to the at least one distal wall portion of the first side than the at least one portable electronic device support portion of the first side is to the at least one distal wall portion of the first side, and
wherein the at least one keyboard support portion of the third side is closer to the at least one distal wall portion of the third side than the at least one portable electronic device support portion of the third side is to the at least one distal wall portion of the third side.

5. The system of claim 3
wherein the at least one keyboard support portion of the first side is a flexible material, and
wherein the at least one keyboard support portion of the third side is a flexible material.

6. The system of claim 1
wherein the at least one middle wall portion of the first side is removably couplable with the portable electronic device, and
wherein the at least one middle wall portion of the third side is removably couplable with the portable electronic device.

7. The system of claim 1
wherein the first side of the keyboard assembly is frictionally couplable to the at least one distal wall portion of the first side of the case assembly, and
wherein the third side of the keyboard assembly is frictionally couplable to the at least one distal wall portion of the third side of the case assembly.

8. The system of claim 1
wherein the first side of the keyboard includes at least one protrusion that is removably couplable to the at least one distal wall portion of the first side of the case assembly, and
wherein the third side of the keyboard includes at least one protrusion that is removably couplable to the at least one distal wall portion of the third side of the case assembly.

9. The system of claim 1
wherein the at least one distal wall portion of the first side of the case assembly includes at least one protrusion that is removably couplable to the first side of the keyboard assembly, and
wherein the at least one distal wall portion of the third side of the case assembly includes at least one protrusion that is removably couplable to the third side of the keyboard assembly.

10. The system of claim 1
wherein the first side of the keyboard includes at least one protrusion,
wherein the at least one distal wall portion of the first side of the case assembly includes at least one protrusion,
wherein the at least one protrusion of the first side of the keyboard is removably couplable with the at least one protrusion of the at least one distal wall portion of the first side of the case assembly,
wherein the third side of the keyboard includes at least one protrusion,
wherein the at least one distal wall portion of the third side of the case assembly includes at least one protrusion, and
wherein the at least one protrusion of the third side of the keyboard is removably couplable with the at least one protrusion of the at least one distal wall portion of the third side of the case assembly.

11. The system of claim 1
wherein the case assembly includes at least one semi-rigid portion to allow for uncoupling of the portable electronic device from the case assembly when the portable electronic device is coupled to the case assembly.

12. The system of claim 1
wherein the second side of the case assembly includes an interior portion and an exterior portion,
wherein the case assembly includes an electrical cable assembly,
wherein the second side of the case assembly includes an aperture from the exterior portion of the second side through the side second to the interior portion of the second side,
wherein the electrical cable assembly extends from the exterior portion of the second side through the aperture of second side to extend beyond the interior portion of the second side,
wherein a portion of the electrical cable assembly extends along the exterior portion of the second side,
wherein a portion of the electrical cable assembly extends along the interior portion of the second side,
wherein the third side of the case assembly includes an interior portion,
wherein a portion of the electrical cable assembly extends along the interior portion of the third side, and
wherein the electrical cable assembly is electrically coupled to the keyboard assembly.

13. The system of claim 1
wherein the third side of the case assembly includes an exterior portion with a stylus-shaped recess.

14. The system of claim 1 further including a flexible hinge,
wherein the flexible hinge is coupled to the case assembly, and
wherein the flexible hinge is coupled to the keyboard assembly.

15. A system for a portable electronic device, the system comprising:
(I) a case assembly including
(A) a base,
(B) a first side extending perpendicular to the base, the first side including at least one distal wall portion, and at least one proximal wall portion, and
wherein the at least one distal wall portion is farther from the base than the at least one proximal wall portion is from the base, and
(C) a second side extending perpendicular to the base and extending parallel with the first side, the second side including at least one distal wall portion, and at least one proximal wall portion,
wherein the at least one distal wall portion is farther from the base than the at least one proximal wall portion is from the base; and
(II) a keyboard assembly including
(A) a base,
(B) a first side extending perpendicular to the base, the first side removably couplable to the at least one distal wall portion of the first side of the case assembly,
wherein the first side of the keyboard includes at least one protrusion that is removably couplable to the at least one distal wall portion of the first side of the case assembly, and
(C) a second side extending perpendicular to the base and extending parallel with to the first side, the second side removably couplable to the at least one distal wall portion of the second side of the case assembly,
wherein the second side of the keyboard includes at least one protrusion that is removably couplable to the at least one distal wall portion of the second side of the case assembly.

16. The system of claim 15
wherein the first side includes at least one keyboard support portion and at least one portable electronic device support portion,
wherein the at least one keyboard support portion of the first side extends perpendicular to the at least one distal wall portion of the first side,
wherein the at least one portable electronic device support portion of the first side extends perpendicular to the at least one distal wall portion of the first side,
wherein the at least one keyboard support portion of the first side is closer to the at least one distal wall portion of the first side than the at least one portable electronic device support portion of the first side is to the at least one distal wall portion of the first side,
wherein the second side includes at least one keyboard support portion and at least one portable electronic device support portion,
wherein the at least one keyboard support portion of the second side extends perpendicular to the at least one distal wall portion of the second side,
wherein the at least one portable electronic device support portion of the second side extends perpendicular to the at least one distal wall portion of the second side, and
wherein the at least one keyboard support portion of the second side is closer to the at least one distal wall portion of the second side than the at least one portable electronic device support portion of the second side is to the at least one distal wall portion of the second side.

17. The system of claim 15
wherein the at least one keyboard support portion of the first side is a flexible material, and
wherein the at least one keyboard support portion of the second side is a flexible material.

18. A system for a portable electronic device, the system comprising:
(I) a case assembly including
(A) a base,
(B) a first side extending perpendicular to the base, the first side including at least one distal wall portion, and at least one proximal wall portion,
wherein the at least one distal wall portion is farther from the base than the at least one proximal wall portion is from the base,
(C) a second side extending perpendicular to the base and extending perpendicular to the first side, and
(D) a third side extending perpendicular to the base and extending perpendicular to the first side, the third side including at least one distal wall portion, and at least one proximal wall portion,
wherein the at least one distal wall portion is farther from the base than the at least one proximal wall portion is from the base; and
(II) a keyboard assembly including
(A) a base,
(B) a first side extending perpendicular to the base, the first side removably couplable to the at least one distal wall portion of the first side of the case assembly,
wherein the distal wall portion of the first side of the case assembly includes at least one protrusion that is removably couplable to the first side of the keyboard assembly,
(C) a second side extending perpendicular to the base and extending perpendicular to the first side, and
(D) a third side extending perpendicular to the base and extending perpendicular to the second side, the third side removably couplable to the at least one distal wall portion of the third side of the case assembly,
wherein the distal wall portion of the third side of the case assembly includes at least one protrusion that is removably couplable to the third side of the keyboard assembly.

19. The system of claim 18
wherein the first side of the keyboard includes at least one protrusion,
wherein the at least one protrusion of the first side of the keyboard is removably couplable with the at least one protrusion of the distal wall portion of the first side of the case assembly,
wherein the third side of the keyboard includes at least one protrusion, and
wherein the at least one protrusion of the third side of the keyboard is removably couplable with the at least one protrusion of the distal wall portion of the third side of the case assembly.

20. The system of claim 18
wherein the second side of the case assembly includes an interior portion and an exterior portion,
wherein the case assembly includes an electrical cable assembly,
wherein the second side of the case assembly includes an aperture from the exterior portion of the second side through the side second to the interior portion of the second side,
wherein the electrical cable assembly includes an electrical connector assembly,
wherein the electrical connector assembly extends from the exterior portion of the second side through the aperture of second side to extend past the interior portion of the second side,
wherein a portion of the electrical cable assembly extends along the exterior portion of the second side,
wherein a portion of the electrical cable assembly extends along the interior portion of the second side,
wherein the third side of the case assembly includes an interior portion,
wherein a portion of the electrical cable assembly extends along the interior portion of the third side, and
wherein the electrical cable assembly is electrically coupled to the keyboard assembly.
